(19) United States
(12) Patent Application Publication
(10) Pub. No.: US 2003/0021661 A1
(43) Pub. Date: Jan. 30, 2003

(54) Flat tire emergency truck

(76) Inventor: Martin Fluss, Calgary (CA)

Correspondence Address: OGILVY RENAULT, 1981 MCGILL COLLEGE AVENUE, SUITE 1600, MONTREAL, QC, H3A2Y3, CA

(21) Appl. No.: 10/216,717

(22) Filed: Aug. 13, 2002

Related U.S. Application Data
(63) Continuation-in-part of application No. 09/910,925, filed on Jul. 24, 2001, now abandoned.

(51) Int. Cl. B65G 7/00; B60B 29/00

(52) U.S. Cl. 414/430

(57) ABSTRACT

A flat tire emergency truck is comprised of a steel cradle provided with a pair of rear wheels supported on a rear axle and a central swiveling front wheel. The cradle has a bottom wall and opposed spaced parallel side walls to receive a vehicle wheel therein. A pivotal rear ramp is secured to the rear axle and has a first inclined ramp section to permit the vehicle wheel to enter the cradle. The rear ramp also has a second ramp section which is actuable by the load of the vehicle wheel to cause the first plate section to pivot upward to an arresting position. The rear ramp is constructed such that when in the loading position, it causes the rear wheel to be wedged off the ground support surface. Arresting means is provided to prevent displacement to the truck when a vehicle wheel is driven in or out of the cradle over the pivotal rear ramp.

### CROSS-REFERENCE TO RELATED APPLICATION

This application is a Continuation-in-Part of application Ser. No. 09/910,925, filed Jul. 24, 2001.

### TECHNICAL FIELD

The present invention relates to a flat tire emergency truck on which a flat tire wheel of a vehicle is positioned and supported whereby the vehicle can be driven to a tire repair destination.

### BACKGROUND ART

Flat tire emergency trucks, generally of the type disclosed in this application, are well known in the art. As examples thereof, reference is made to U.S. Pat. Nos. 2,608,312; 2,350,118, 3,224,611, 4,465,421, 4,913,459 and 4,726,727. These patents show examples of different constructions of such trucks. It can be observed that some of these are not provided with fully automatic safety loading and arresting mechanisms and some require manual attachment between the truck and the wheels. Further, some wheel arresting mechanisms are not secure and may disconnect during use. Some of these trucks are also not compact in structure and are a nuisance when stored in the trunk of a vehicle. Furthermore, some of these trucks may be subjected to displacement and be projected when a flat tire vehicle wheel is being driven or unloaded from the truck and it could prove hazardous to the user and damage the vehicle. Still further, because the vehicle wheel has a portion of the vehicle load in the cradle of the truck, it is important to have a cradle which is sturdy and which is provided with arresting mechanisms capable of withstanding these loads, particularly if the emergency truck is often utilized. None of the prior art trucks have the requisite structure to be usefully commercialized.

### SUMMARY OF INVENTION

It is therefore a feature of the present invention to provide a flat tire emergency truck which substantially overcomes the above-mentioned disadvantages of the prior art and which is safe and easy to use and which is storable in a compact space.

According to the above feature and others, and from a broad aspect, the present invention provides a flat tire emergency truck which comprises a steel cradle having a bottom wheel support wall, side walls and an open rear end. A rear axle is secured across the side walls adjacent the open rear end and elevated from the bottom support wall. A rear wheel is secured at opposed ends of the rear axle outside the side walls. A front wheel is secured under a front section of the cradle substantially central thereof. The front and rear wheels support the cradle elevated from a ground surface. A front wheel abutment is secured to the cradle above the bottom support wall rearwardly of the front wheel for arresting forward movement of a vehicle wheel positioned in the cradle. A pivotal rear ramp is pivotally secured to the rear axle between the side walls. The rear ramp has a first inclined ramp section pivotally displaceable from a loading position, to permit a vehicle wheel to enter the cradle, and an arresting position, to retain a vehicle wheel in the cradle. The rear ramp has a second plate section which is secured to the first plate section and projects inwardly in the cradle and upwards of the rear axle. The second plate section causes the first plate section to pivot upwardly when a load from a vehicle wheel is driven thereon whereby the second plate section is retained in the arresting position by the vehicle wheel. The rear ramp is constructed such that when in the loading position, it causes the rear wheel to be wedged off the ground support surface. Arresting means is provided to prevent displacement to the truck when a vehicle wheel is driven in or out of the cradle over the pivotal rear ramp.

### BRIEF DESCRIPTION OF DRAWINGS

A preferred embodiment of the present invention will now be described with reference to the accompanying drawings in which:

FIG. 1 is a perspective view of the flat tire emergency truck of the present invention;

FIG. 2 is a top view of FIG. 1;

FIG. 3 is a side view of FIG. 1;

FIG. 4 is a front view of FIG. 1;

FIG. 5 is a rear view of FIG. 1 showing the pivotal rear ramp at an arresting elevated position;

FIG. 6 is a bottom view of FIG. 1;

FIG. 7A is a fragmented section view showing the construction and operation of the pivotal rear ramp and the truck arresting mechanism;

FIG. 7B is a fragmented bottom view showing the truck arresting mechanism in the engaged position;

FIG. 7C is a view similar to FIG. 7B, but showing the truck arresting mechanism in the disengaged position;

FIG. 8A is a fragmented side view illustrating the construction of a rear wheel locking mechanism; and

FIG. 8B is an enlarged view of the gear and latch forming the rear wheel locking mechanism.

### DESCRIPTION OF PREFERRED EMBODIMENTS

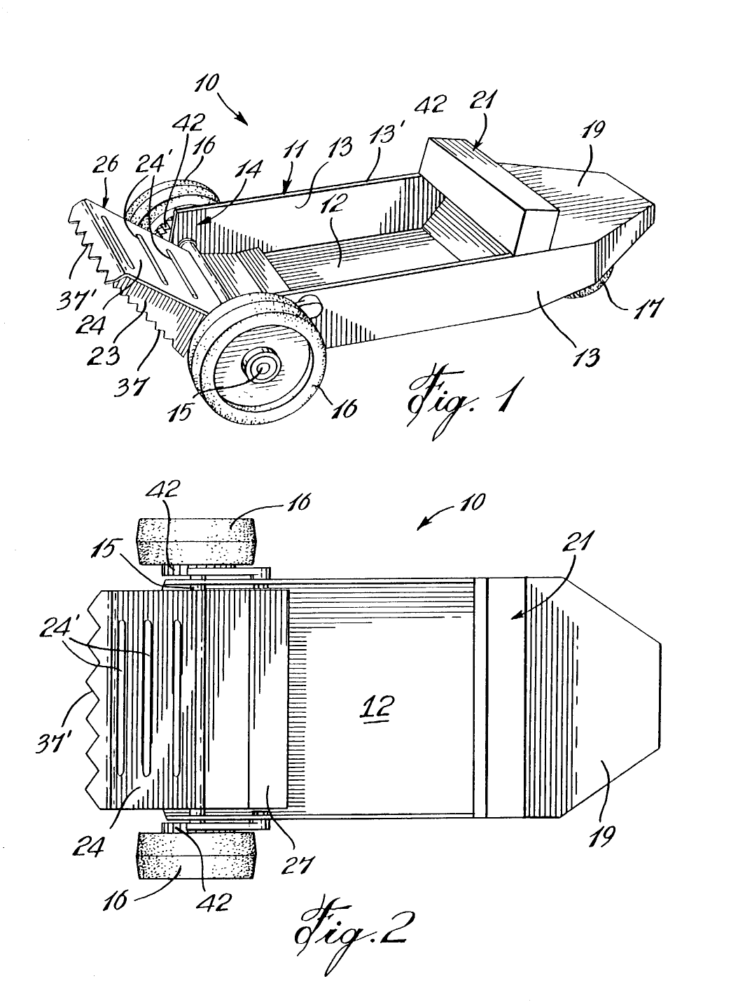

Referring now to the drawings, and more particularly to FIGS. 1 to 6, there is shown generally at 10 the flat tire emergency truck of the present invention. The truck has a reinforced steel cradle 11 defined by a bottom wheel support wall 12, side walls 13 and an open rear end 14. A steel shaft rear axle 15 is secured across the side walls 13 adjacent the open rear end 14 and is elevated slightly from the bottom support wall 12, as thereinshown. A rear wheel 16 is secured at opposed ends of the rear axle 15 and disposed outside the side walls 13. A front wheel 17, as better seen in FIG. 4, is secured to a swiveling yoke 18 secured under an elevated front frame section 19 of the cradle 11. The swiveling yoke 18 provides approximately 45 degrees of swiveling motion to the front wheel 17. The wheels are heavy-duty wheels made from steel and have been tested to support a load up to 97,500 lbs. They are also mounted on self-lubricating bearings, not shown.

The front and rear wheels support the cradle bottom wall 11 elevated from a ground surface 20 as can also be seen from FIG. 4.

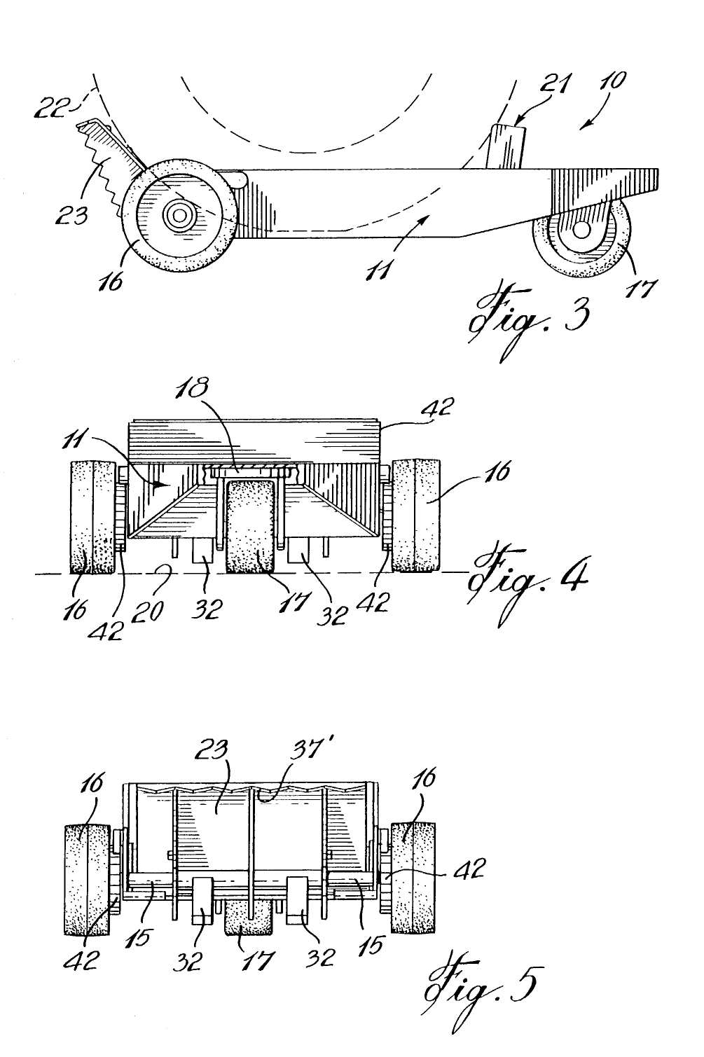

A front wheel abutment 21 is secured to, or formed integral with, the cradle 11 and extends above the bottom wheel support wall 12 and projects above the top edges 13′ of the side walls 13. It is disposed in a forward section of the cradle and aligned behind the front wheel 17 whereby to arrest forward movement of a vehicle wheel 22, as shown in phantom lines in FIG. 3, when positioned in the cradle.

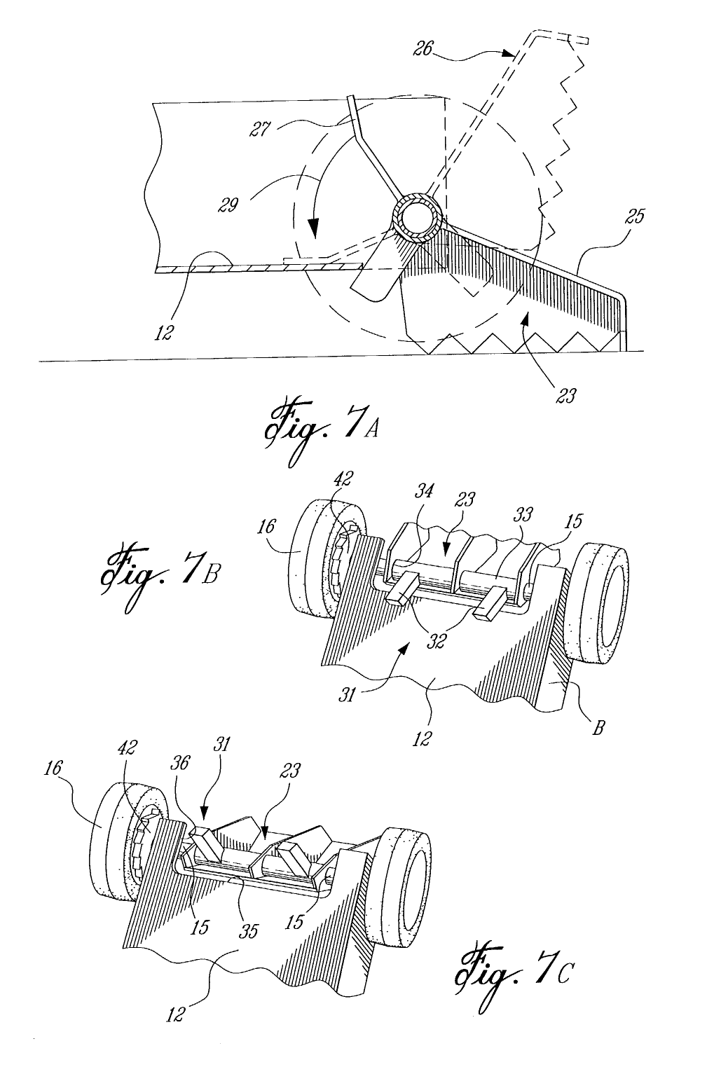

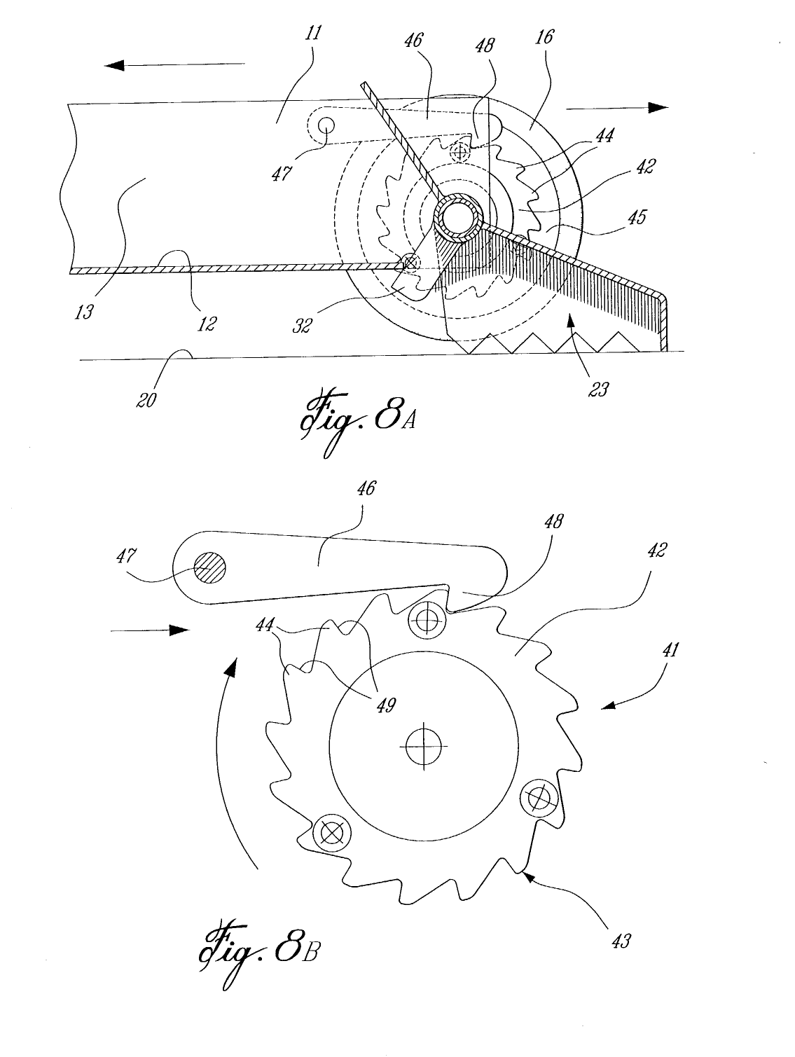

The flat tire emergency truck 10 is also provided with a pivotal rear ramp 23 pivotally secured to the rear axle 15 between the side walls 13. The rear ramp 23 has a first inclined ramp section 24 pivotally displaceable from a loading position 25, as shown in FIG. 7A, to an arresting position 26 shown in phantom lines, to permit a vehicle wheel 22 to enter and become captive in the cradle. This pivotal action of the first inclined ramp section is provided by a second plate section 27 which is secured or integrally formed with the first plate section and projects inwardly and upwards of the rear axle as better illustrated in FIG. 7A. As shown in FIG. 7A, the second plate section 27 will hinge inwardly downward between the cradle side walls 13 to rest on the cradle bottom wall 12 as a vehicle wheel 22 enters the cradle over the ramp. The second plate section 27 simultaneously causes the first inclined ramp section 24 to move upwardly in the direction of arrow 28 with the second plate section 27 moving downwardly in the direction of arrow 29. Accordingly, the first plate-section is retained in its arresting position 26 by the vehicle wheel load against the second plate section 27.

Referring now to FIGS. 7B and 7C, there is shown generally at 31 an arresting means to prevent displacement of the truck when a vehicle wheel, such as the wheel 22, is driven in or out of the cradle over the pivotal rear ramp 23. This arresting means is comprised by a pair of stopper bars 32 which are welded to a respective sleeve 33, which are disposed about the rear axle 15 and welded to the pivotal ramp 23, such as illustrated by reference numeral 34. Accordingly, these stopper bars project under the pivotal rear ramp whereby to engage with a rear edge portion 35 of the cradle bottom wall 12 when the rear ramp is disposed in a loading position, as illustrated in FIG. 8A, with the rear wheels being wedged above the ground support surface 20 to prevent the truck from being pushed forward when a vehicle wheel is driven up the rear ramp 23 into the cradle. The rear edge 35 is defined by a recessed rear portion 36 which extends spaced forwardly from the rear axle 15.

With additional reference now to FIGS. 8A to 8B, it can be seen that the arresting means further comprises a rear wheel locking means or mechanism 41 which prevents clockwise rotation of the rear wheels 16 and forward projection of the truck during unloading of the vehicle wheel from the cradle and over the rear ramp while the rear wheels 16 are on the support surface 20. This rear wheel locking mechanism is constituted by at least one gear, herein a pair of gears 42 having an outer toothed periphery 43 defined by a plurality of teeth 44. The gears 42 are secured for rotation with the rear axle and therefore may be secured to the axle or to the inner side wall 45 of the wheels 16. A pivotal latch 46 is pivotally secured adjacent each one of the gears and secured to a respective one of the side walls 13 by a pivot pin 47. The latches 46 are aligned with the outer periphery 43 of its respective gear 42.

As can be seen more clearly in FIG. 8B, the pivotal latch has a hook end 48 which is disposed on the toothed periphery 43 of its associated gear and it engages a leading edge 49 of a tooth 44 when the gear is rotated clockwise by the rear axle or rear wheels whereby to prevent this clockwise rotation of the rear wheels and rearward displacement of the cradle when a vehicle wheel is dismounted from the cradle over the rear ramp. Once the ramp touches the ground, the rear wheels are wedged up and out of contact with the ground surface and the stopper bars 32 become engaged with the cradle bottom wall 12 preventing movement of the truck when a load is on the ramp.

When a wheel is engaged in the cradle, and the vehicle is moved forwardly, then the gears 42 are turning counter-clockwise and the latch 46 cannot engage with the teeth but rides on these teeth. Accordingly, with the stopper mechanism and the rear wheel locking mechanism, there is provided a very safe cradle capable of mounting a vehicle wheel in a safe and efficient manner and preventing the truck from being projected either forwardly or rearwardly which could cause injury to the user or others or to the vehicle.

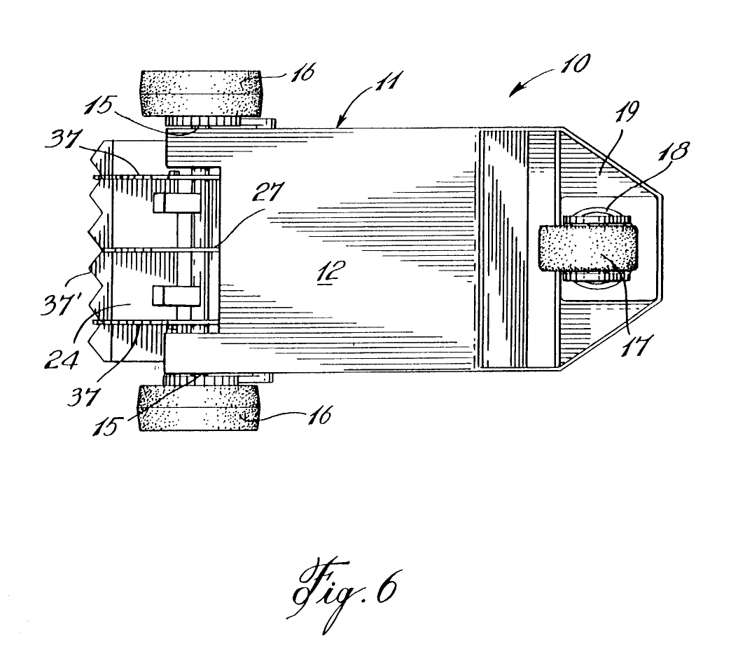

As can be seen from FIGS. 1, 6 and 7A, the first inclined ramp section 27 is provided with ground engagement means in the form of serrations 37 disposed for engagement with a ground surface 20 which is usually a paved road or other hard ground surface. These serrations 37 when lying on the ground surface 20 are spaced from the central longitudinal axis 38 of the rear axle 15 a distance which is greater than the rear wheel radius. As can be seen more clearly from FIGS. 5 and 6, the ground engagement means or serrations 37 are constituted by two or more spaced vertical steel plates 39 secured under the first inclined ramp section 25 by welding or other means. These plates are substantially triangular in shape and their bottom straight edges are formed with the serrations 37. The outer end edge portion 40 of the first inclined ramp section 24 can also be formed with a serrated edge 37′, as shown in FIG. 1. The top surface of the first inclined section 24 is also provided with ribs 24′ for enhanced gripping by a vehicle tire displaced thereover. The plates 39 are dimensioned such that when the serrations are pressed against the ground surface 20 by the load of the vehicle tire 222 the rear wheels 16 of the truck are lifted off the ground surface 20, as shown in FIG. 7A.

It is pointed out that the flat tire emergency truck of the present invention provides many advantages to the public. The truck as described herein can handle tire sizes up to a width of 270 mm and a length of 555 mm which is an improvement of approximately 25 percent over the prior art cradles. Also, the load on the front wheel of the truck is decreased as compared to the prior art trucks due to the structure of the truck 10. The use of the truck is also simplified to avoid misuse by the consumer and the structure of the cradle and the ramps and the front wheel abutment 21 are of very strong and sturdy construction. Also, when backing up the vehicle out of the cradle, there is positive engagement of the back wheels to prevent rearward displacement of the truck and when the ramp is engaged with the ground surface, the rear wheels are wedged out of contact with the ground surface and the stopper bars also prevent the truck from being shot out from under the wheel causing injury and/or damage. By increasing the capacity to handle tires in the range of 195-70 R14 or equivalent, the flat tire emergency truck can be used with heavier and larger vehicles such as utility vehicles. The back ramp is an integrated part of the truck and is constructed from a sturdy steel plate as well as the front gate being constructed from rigid steel components, therefore providing a sturdy cradling of the deflated tire and wheel to prevent accidental disengagement. The truck of the present invention can be used for front or rear wheel drive vehicles due to its locking safety features.

It is within the ambit of the present invention to cover any obvious modifications of the preferred embodiment described herein, provided such modifications fall within the scope of the appended claims.

I claim:

1. A flat tire emergency truck comprising a steel cradle having a bottom wheel support wall, side walls and an open rear end; a rear axle secured across said side walls adjacent said open rear end and elevated from said bottom support wall, a rear wheel secured at opposed ends of said rear axle outside said side walls, a front wheel secured under a front section of said cradle substantially central thereof, said front and rear wheels supporting said cradle elevated from a ground surface, a front wheel abutment secured to said cradle above said bottom support wall rearwardly of said front wheel for arresting forward movement of a vehicle wheel positioned in said cradle, a pivotal rear ramp pivotally secured to said rear axle between said side walls; said rear ramp having a first inclined ramp section pivotally displaceable from a loading position to permit a vehicle wheel to enter said cradle, and an arresting position to retain a vehicle wheel in said cradle; said rear ramp having a second plate section secured to said first plate section and projecting inwardly in said cradle and upwards of said rear axle, said second plate section causing said first plate section to pivot upwardly when a vehicle wheel is driven thereon whereby said first plate section is retained in said arresting position by said vehicle wheel, said rear ramp being constructed such that when in said loading position causes said rear wheels to be wedged off said ground support surface, and arresting means to prevent displacement of said truck when a vehicle wheel is driven in or out of said cradle over said pivotal rear ramp.

2. A flat tire emergency truck as claimed in claim 1 wherein said arresting means is comprised by an arresting element immovably secured to said rear ramp and projecting from under said pivotal rear ramp whereby to engage with a rear edge portion of said cradle when said rear ramp is disposed at said loading position with said rear wheels above a ground support surface to prevent said truck from being pushed forward when a vehicle wheel is driven up said rear ramp into said cradle.

3. A flat tire emergency truck as claimed in claim 2 wherein said arresting element is constituted by a pair of stopper bars welded to a respective sleeve disposed about said rear axle and connected to said rear ramp.

4. A flat tire emergency truck as claimed in claim 3 wherein said bottom support wall has a recessed rear portion which defines said rear edge and extending spaced forwardly of said rear axle.

5. A flat tire emergency truck as claimed in claim 2 wherein said arresting means further comprises a rear wheel locking means to prevent clockwise rotation of said rear wheels and forward projection of said truck during unloading of a vehicle wheel from said cradle and over said rear ramp while said rear wheels are on said support surface.

6. A flat tire emergency truck as claimed in claim 5 wherein said rear wheel locking means prevents said truck from being displaced in a rearward direction, said ground support surface being a hard ground surface.

7. A flat tire emergency truck as claimed in claim 5 wherein said rear wheel locking means is constituted by at least one gear secured for rotation with said rear axle, said gear having an outer toothed periphery and a pivotal latch pivotally secured adjacent one of said sidewalls of said cradle, said pivotal latch having a hook end disposed on said toothed periphery and engaging a leading edge of a tooth of a plurality of teeth formed in said toothed periphery when said gear is rotated clockwise by said rear axle and said rear wheels, said hook end being liberated from engagement when said rear axle and said rear wheels are rotated counter-clockwise during forward displacement of said truck.

8. A flat tire emergency truck as claimed in claim 7 wherein there are two of said gears, each gear being secured to an inner wall of a respective one of said rear wheels or said rear axle adjacent said wheels and rotating therewith, there being two of said pivotal latches, each pivotally secured to a respective one of said side walls and disposed adjacent an outer surface of said side walls and in planar alignment with a respective one of said gears.

9. A flat tire emergency truck as claimed in claim 1 wherein said first inclined ramp section is provided with ground engagement means secured thereunder and forming a straight ground engagement surface, said straight ground engagement surface when lying on a ground surface being spaced from a central longitudinal axis of said rear axle a distance greater than the radius of said rear wheels.

10. A flat tire emergency truck as claimed in claim 9 wherein said ground engagement means is constituted by two or more spaced vertical steel plates secured under said first inclined ramp section, said straight ground engagement surface being formed by a straight serrated lower edge of said vertical steel plates.

11. A flat tire emergency truck as claimed in claim 1 wherein said front wheel abutment is a barrier wall projecting above an open top end of said cradle in a forward end thereof and secured to said front section of said truck.

12. A flat tire emergency truck as claimed in claim 1 wherein said front wheel is secured to a swiveling yoke secured under an elevated front frame section of said cradle, said swiveling yoke providing approximately 45 degrees of swiveling motion to said front wheel.
